(19) United States
(12) Patent Application Publication
(10) Pub. No.: US 2007/0040105 A1
(43) Pub. Date: Feb. 22, 2007

(54) Driver for solid-state image sensing device

(75) Inventor: Kenichi Kido, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/475,241

(22) Filed: Jun. 27, 2006

(30) Foreign Application Priority Data
Jun. 30, 2005 (JP) 2005-192838

(51) Int. Cl. G01N 21/01

(52) U.S. Cl. 250/214 DC

(57) ABSTRACT

A solid-state image sensing device drive unit of the present invention includes a randomly accessible SRAM for storing waveform information on a drive signal for a solid-state image sensing device, and a comparator for reading the waveform information from the SRAM and creating the drive signal based on the read waveform information.

### FIELD OF THE INVENTION

The present invention relates to a drive unit for a solid-state image sensing device including a CCD or the like.

### BACKGROUND OF THE INVENTION

FIG. 2 shows a configuration of an interline transfer solid-state image sensing device 1 used for a digital still camera. The solid-state image sensing device 1 forms an imaging area including a plurality of pixels 11 by having color filter arrays on a plurality of photo sensors arranged in the form of a matrix, and has a plurality of vertical registers 12 for transferring electric charges of a plurality of arrays of vertically arranged pixels 11, and a horizontal register 13 for outputting the electric charges transferred by these vertical registers 12 every one horizontal period.

The above solid-state image sensing device 1 has an input terminal 8 for a first vertical transfer pulse Vφ1 having a first phase, an input terminal 7 for a second vertical transfer pulse Vφ2 having a second phase, input terminals 6, 5 for a pair of third vertical transfer pulses Vφ3A and Vφ3B having a third phase, an input terminal 4 for a fourth vertical transfer pulse Vφ4 having a fourth phase, input terminals 3, 2 for a pair of fifth vertical transfer pulses Vφ5A and Vφ5B having a fifth phase, and an input terminal 1 for a sixth vertical transfer pulse Vφ6 having a sixth phase. Feeding these vertical transfer pulses to the respective input terminals causes electric charges accumulated in the vertical registers 12 to be transferred to the horizontal register 13.

The solid-state image sensing device 1 also has input terminals 21, 16 for a pair of first horizontal transfer pulses Hφ1A and Hφ1B, and input terminals 22, 17 for a pair of second horizontal transfer pulses Hφ2A and Hφ2B provided by inverting the first horizontal transfer pulses, respectively. Feeding these horizontal transfer pulses to the respective input terminals causes the electric charges transferred from the vertical registers 12 to the horizontal register 13 to be output outside.

The above solid-state image sensing device 1 is driven by a drive unit shown in FIG. 10, for example. The solid-state image sensing device 1 has a vertical transfer drive circuit 2 and a horizontal transfer drive circuit 3 connected thereto. The vertical transfer drive circuit 2 feeds the above first vertical transfer pulse Vφ1, second vertical transfer pulse Vφ2, pair of third vertical transfer pulses Vφ3A, Vφ3B, fourth vertical transfer pulse Vφ4, pair of fifth vertical transfer pulses Vφ5A, Vφ5B and sixth vertical transfer pulse Vφ6, while the horizontal transfer drive circuit 3 feeds the pair of first horizontal transfer pulses Hφ1A, Hφ1B, and pair of second horizontal transfer pulses Hφ2A, Hφ2B.

A timing generator (TG) 7 is connected to the vertical transfer drive circuit 2 and horizontal transfer drive circuit 3. The timing generator 7 feeds to the vertical transfer drive circuit 2 a first vertical timing pulse, a second vertical timing pulse, a pair of third vertical timing pulses, a fourth vertical timing pulse, a pair of fifth vertical timing pulses, a sixth vertical timing pulse and charge read pulses. The timing generator 7 also feeds to the horizontal transfer drive circuit 3 a pair of first horizontal timing pulses and a pair of second horizontal timing pulses.

The timing generator 7 creates, using a counter (not shown) as described later, the first vertical timing pulse, second vertical timing pulse, pair of third vertical timing pulses, fourth vertical timing pulse, pair of fifth vertical timing pulses, sixth vertical timing pulse and charge read pulses, and feeds these pulses to the vertical transfer drive circuit 2. The timing generator 7 also creates, using a drive clock, the pair of first horizontal timing pulses and pair of second horizontal timing pulses, and feeds these pulses to the horizontal transfer drive circuit 3.

The vertical transfer drive circuit 2 creates the first to sixth vertical transfer pulses Vφ1, Vφ2, Vφ3A, Vφ3B, Vφ4, Vφ5A, Vφ5B and Vφ6 from the charge read pulses and first to sixth vertical timing pulses provided from the timing generator 7, and feeds these pulses to the solid-state image sensing device 1. On the other hand, the horizontal transfer drive circuit 3 creates the pair of first horizontal transfer pulses Hφ1A, Hφ1B and pair of second horizontal transfer pulses Hφ2A, Hφ2B by amplifying the pair of first horizontal timing pulses and pair of second horizontal timing pulses provided from the timing generator 7, and feeds these pulses to the solid-state image sensing device 1.

A CCD output provided from the solid-state image sensing device 1 is output through a CDS/AGC circuit 5 including a sampling part CDS and a gain control part AGC, and an A/D converter 6 to a subsequent circuit. The timing generator 7 feeds to the CDS/AGC circuit 5 a sampling signal SHP, SHD for sampling the CCD output. The timing generator 7 feeds to the A/D converter 6 a sampling signal ADCK for A/D conversion.

FIG. 11 shows a configuration of a charge read pulse and vertical timing pulse creation part of the above timing generator 7. The timing generator includes a horizontal counter 71 that counts up in synchronization with a drive clock, a vertical counter 72 that is for counting the number of lines of one field, and counts up every one horizontal period, and a field counter 73 that is for counting the number of fields when all pixels to constitute one screen are read in a plurality of divided fields, and counts up every one vertical period. A maximum value storing register device 74 is connected to these counters 71, 72, 73. The maximum value storing register device 74 feeds maximum values HMax, VMax, FMax to be counted to these counters 71, 72, 73, respectively.

The timing generator also includes a waveform information storing register device 75 and an operation information storing register device 76. The waveform information storing register device 75 stores count values of the horizontal counter 71 at rise time points and fall time points of each of the charge read pulses and vertical timing pulses where the polarity changes. On the other hand, the operation information storing register device 76 stores a count value of the vertical counter 72 at a time point to start creating a pulse, a count value of the field counter 73, and a register number of the waveform information storing register device 75 storing count values for the pulse.

A comparator 77 has input terminals thereof connected to output terminals of the above three counters 71, 72, 73, output terminals of the waveform information storing register device 75, and an output terminal of the operation information storing register device 76.

When a count value fed from the vertical counter 72 and a count value fed from the field counter 73 correspond with a vertical count value and field count value, respectively, fed from the operation information storing register device 76, the comparator 77 selects a count value from a register having a register number fed from the operation information storing register device 76 from among the count values fed from the waveform information storing register device 75, and starts comparing the selected count value with a count value from the horizontal counter 71. When the both count values are identical, the comparator 77 changes an output thereof from high to low, or low to high. The charge read pulses and vertical timing pulses are created in this way.

For example, when the comparator 77 selects count values of “1”, “3” and “5”, a first vertical timing pulse XV1 shown in FIG. 12 is created. As illustrated, the vertical timing pulse XV1 changes from low to high at a time point when the count value h_cunt of the horizontal counter 71 turns “1”, thereafter changes from high to low at a time point when the count value h_cunt turns “3”, and further changes from low to high at a time point when the count value h_cunt turns “5”.

There has been proposed a counter circuit that repeatedly performs a plurality of counter processes in a time division manner to thereby create a plurality of pulse signals with different periods (see JP 2003-258628, A).

In the above conventional solid-state image sensing device drive unit, the waveform information storing register device 75 of the timing generator shown in FIG. 11 stores counter values for many pulses, such as first to sixth charge read pulses XV1read to XV6read, first to sixth vertical timing pulses XV1transfer to XV6transfer for transferring read electric charges to the horizontal register, and first to sixth vertical timing pulses for performing a high-speed discharge operation for discharging at a high speed electric charges that have leaked into the vertical registers from the pixels in exposure. In addition, diversification of solid-state image sensing devices complicates waveforms of pulses, so that many count values are stored for each of the pulses. Thus, the waveform information storing register device 75 stores many count values for many pulses, and therefore many registers for constituting the register device 75 must be connected to the comparator 77. This has caused a problem of a complicated circuit configuration. In addition, the comparator 77 must be provided with many gates for inputting thereto count values from many registers constituting the waveform information storing register device 75. This has caused a problem of the comparator 77 being larger, making the circuit scale larger.

### SUMMARY OF THE INVENTION

An object of the present invention is to provide a solid-state image sensing device drive unit with a simpler circuit configuration and smaller circuit scale than those of conventional ones.

A solid-state image sensing device drive unit of the present invention includes:

a randomly accessible memory for storing waveform information on a drive signal for a solid-state image sensing device; and

a signal creation circuit for reading the waveform information from the memory and creating the drive signal based on the read waveform information.

The above solid-state image sensing device drive unit of the present invention employs a random access memory such as an SRAM, for example, as a memory for storing waveform information on a drive signal. The random access memory such as an SRAM allows one memory cell to be selectively accessed depending on the address, and therefore needs only a single output terminal to be connected to the signal creation circuit. This provides a simpler circuit configuration. In addition, the signal creation circuit needs to have only a single gate for inputting thereto the waveform information from the memory. This makes the signal creation circuit smaller, providing a smaller circuit scale.

A specific configuration includes a counter that counts up with a constant period. The waveform information includes a count value of the counter at a time point when the drive signal changes in value. The signal creation circuit compares a count value of the counter with the count value stored in the memory, and changes an output value at a time point when the both count values are identical. According to the specific configuration, the signal creation circuit changes an output value thereof at a time point when a count value of the counter corresponds with the count value stored in the memory to thereby create the drive signal.

Another specific configuration is capable of creating a drive signal including a plurality of pulses having the same waveform. The waveform information includes an increment of a count value of the counter between time points when the drive signal changes in value. The signal creation circuit repeats an operation of changing an output value at a time point when the count value of the counter increases by the increment.

According to the above specific configuration, the repetition of the operation of changing the output value at a time point when the count value of the counter increases by the increment stored in the memory creates the drive signal including a plurality of pulses having the same waveform. The specific configuration needs the memory to store waveform information on only a single pulse, and can reduce waveform information stored in the memory compared with a configuration where a memory stores waveform information on all pulses constituting a drive signal.

A further specific configuration includes an information store for storing creation start information representing a time point to start creating a drive signal, and address information representing a storage start address for waveform information on the drive signal. The signal creation circuit starts reading the waveform information from the storage start address represented by the address information stored in the information store at the time point represented by the creation start information stored in the information store.

The above specific configuration starts reading the waveform information from the storage start address represented by the address information stored in the information store at the time point represented by the creation start information stored in the information store, and starts an operation of creating the drive signal based on the read waveform information.

As described above, the solid-state image sensing device drive unit of the present invention provides a simpler circuit configuration and smaller circuit scale than those of conventional ones.

### BRIEF DESCRIPTION OF THE DRAWINGS

FIG. 1 is a block diagram showing a configuration of a solid-state image sensing device drive unit of the present invention;

FIG. 2 is a block diagram showing a configuration of a solid-state image sensing device;

FIG. 3 is a block diagram showing a configuration of a timing generator of the above solid-state image sensing device drive unit;

FIG. 4 is a drawing showing operation information in a monitor mode;

FIG. 5 is a drawing showing operation information in an all pixels capture mode;

FIG. 6 is a drawing showing waveform information on a vertical timing pulse for transferring read electric charges to a vertical register;

FIG. 7 is a drawing showing waveform information on a vertical timing pulse for performing a high-speed discharge operation;

FIG. 8 is a time chart showing a manner of creating a first vertical timing pulse and second vertical timing pulse based on the waveform information shown in FIG. 6;

FIG. 9 is a time chart showing a manner of creating a first vertical timing pulse and second vertical timing pulse based on the waveform information shown in FIG. 7;

FIG. 10 is a block diagram showing a configuration of a conventional solid-state image sensing device drive unit;

FIG. 11 is a block diagram showing a configuration of a timing generator of the above solid-state image sensing device drive unit; and

FIG. 12 is a time chart showing how the above timing generator creates a vertical timing pulse.

### DETAILED DESCRIPTION OF EMBODIMENT

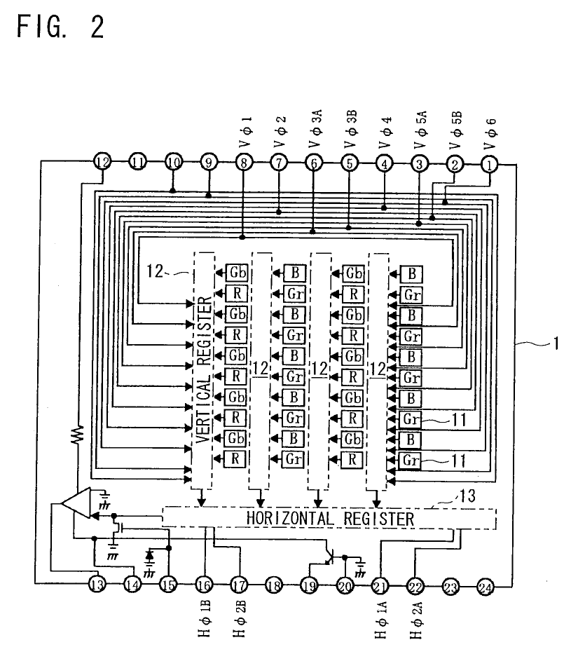

The present invention embodied in a drive unit for a solid-state image sensing device including a CCD will be specifically described below with reference to the drawings. A solid-state image sensing device drive unit of the present invention is for driving a solid-state image sensing device 1 shown in FIG. 2. The solid-state image sensing device 1 has an input terminal 8 for a first vertical transfer pulse Vφ1 having a first phase, an input terminal 7 for a second vertical transfer pulse Vφ2 having a second phase, input terminals 6, 5 for a pair of third vertical transfer pulses Vφ3A and Vφ3B having a third phase, an input terminal 4 for a fourth vertical transfer pulse Vφ4 having a fourth phase, input terminals 3, 2 for a pair of fifth vertical transfer pulses Vφ5A and Vφ5B having a fifth phase, and an input terminal 1 for a sixth vertical transfer pulse Vφ6 having a sixth phase. Feeding these vertical transfer pulses to the respective input terminals causes electric charges accumulated in vertical registers 12 to be transferred to a horizontal register 13.

The solid-state image sensing device 1 also has input terminals 21, 16 for a pair of first horizontal transfer pulses Hφ1A and Hφ1B, and input terminals 22, 17 for a pair of second horizontal transfer pulses Hφ2A and Hφ2B provided by inverting the first horizontal transfer pulses. Feeding these horizontal transfer pulses to the respective input terminals causes the electric charges transferred from the vertical registers 12 to the horizontal register 13 to be output outside.

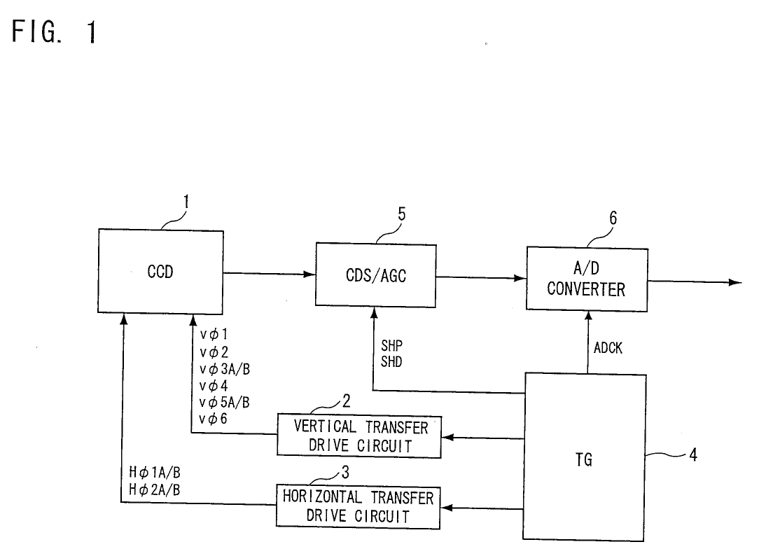

FIG. 1 shows a configuration of the solid-state image sensing device drive unit of the present invention. The above solid-state image sensing device 1 has a vertical transfer drive circuit 2 and a horizontal transfer drive circuit 3 connected thereto. The vertical transfer drive circuit 2 feeds the above first vertical transfer pulse Vφ1, second vertical transfer pulse Vφ2, pair of third vertical transfer pulses Vφ3A, Vφ3B, fourth vertical transfer pulse Vφ4, pair of fifth vertical transfer pulses Vφ5A, Vφ5B and sixth vertical transfer pulse Vφ6, while the horizontal transfer drive circuit 3 feeds the pair of first horizontal transfer pulses Hφ1A, Hφ1B, and pair of second horizontal transfer pulses Hφ2A, Hφ2B.

A timing generator (TG) 4 is connected to the vertical transfer drive circuit 2 and horizontal transfer drive circuit 3. The timing generator 4 feeds to the vertical transfer drive circuit 2 a first vertical timing pulse, a second vertical timing pulse, a pair of third vertical timing pulses, a fourth vertical timing pulse, a pair of fifth vertical timing pulses, a sixth vertical timing pulse and charge read pulses. The timing generator 4 also feeds to the horizontal transfer drive circuit 3 a pair of first horizontal timing pulses and a pair of second horizontal timing pulses.

The timing generator 4 creates, using a counter (not shown) as described later, the first vertical timing pulse, second vertical timing pulse, pair of third vertical timing pulses, fourth vertical timing pulse, pair of fifth vertical timing pulses, sixth vertical timing pulse and charge read pulses, and feeds these pulses to the vertical transfer drive circuit 2. The timing generator 4 also creates, using a drive clock, the pair of first horizontal timing pulses and pair of second horizontal timing pulses, and feeds these pulses to the horizontal transfer drive circuit 3.

The vertical transfer drive circuit 2 creates the first to sixth vertical transfer pulses Vφ1, Vφ2, Vφ3A, Vφ3B, Vφ4, Vφ5A, Vφ5B and Vφ6 from the charge read pulses and first to sixth vertical timing pulses provided from the timing generator 4, and feeds these pulses to the solid-state image sensing device 1. On the other hand, the horizontal transfer drive circuit 3 creates the pair of first horizontal transfer pulses Hφ1A, Hφ1B and pair of second horizontal transfer pulses Hφ2A, Hφ2B by amplifying the pair of first horizontal timing pulses and pair of second horizontal timing pulses provided from the timing generator 4, and feeds these pulses to the solid-state image sensing device 1.

A CCD output provided from the solid-state image sensing device 1 is output through a CDS/AGC circuit 5 including a sampling part CDS and a gain control part AGC, and an A/D converter 6 to a subsequent circuit. The timing generator 4 feeds to the CDS/AGC circuit 5 a sampling signal SHP, SHD for sampling the CCD output. The timing generator 4 feeds to the A/D converter 6 a sampling signal ADCK for A/D conversion.

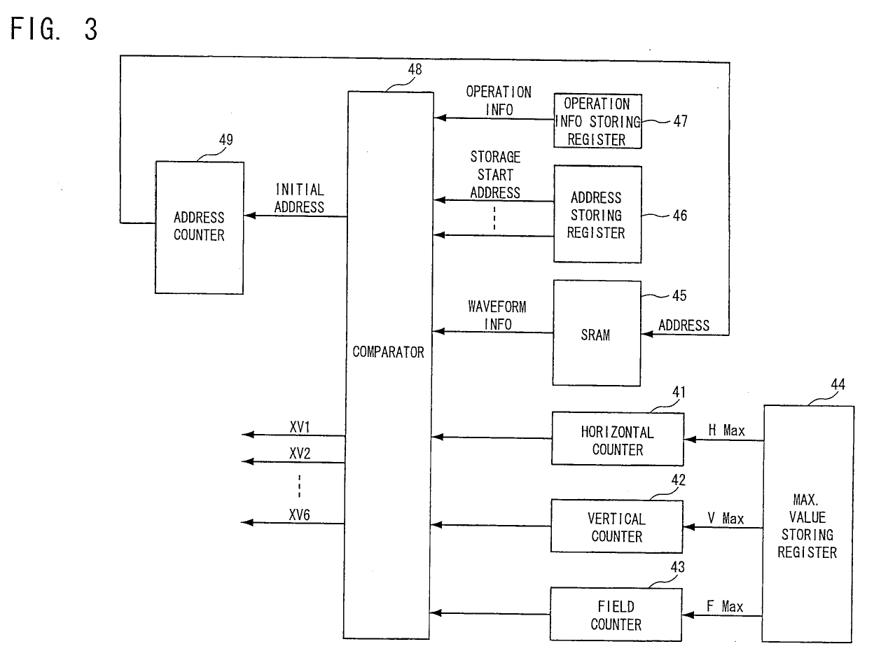

FIG. 3 shows a charge read pulse and vertical timing pulse creation part of the above timing generator 4. The timing generator includes a horizontal counter 41 that counts up in synchronization with a drive clock, a vertical counter 42 that is for counting the number of lines of one field, and counts up every one horizontal period, and a field counter 43 that is for counting the number of fields when all pixels to constitute one screen are read in a plurality of divided fields, and counts up every one vertical period. A maximum value storing register device 44 is connected to these counters 41, 42, 43. The maximum value storing register device 44 feeds maximum values HMax, VMax, FMax to be counted to these counters 41, 42, 43, respectively.

The timing generator also includes an SRAM 45. The SRAM 45 stores waveform information including count values of the horizontal counter 41 at rise time points and fall time points of each of the charge read pulses and vertical timing pulses where the polarity (value) changes.

The timing generator further includes an address storing register device 46 and an operation information storing register device 47. The address storing register device 46 stores storage start addresses for the waveform information stored in the SRAM 45. On the other hand, the operation information storing register device 47 stores operation information including a count value of the vertical counter 42 at a time point to start creating a pulse, a count value of the field counter 43, and a storage start address in the SRAM 45 storing waveform information for the pulse.

A comparator 48 has input terminals thereof connected to output terminals of the above three counters 41, 42, 43, an output terminal of the SRAM 45, output terminals of the address storing register device 46, and an output terminal of the operation information storing register device 47. The comparator 48 has an output terminal thereof connected to an input terminal of an address counter 49. The counter 49 has an output terminal thereof connected to an input terminal of the SRAM 45.

When a count value fed from the vertical counter 42 and a count value fed from the field counter 43 correspond with a vertical count value and field count value, respectively, included in the operation information fed from the operation information storing register device 47, the comparator 48 selects a storage start address included in the operation information from among the storage start addresses fed from the address storing register device 46, and sets the selected storage start address in the address counter 49 as an initial address.

The address set in the address counter 49 is fed to the SRAM 45, and then waveform information stored in the address in the SRAM 45 is read to the comparator 48. The comparator 48 compares a count value included in the read waveform information with a count value from the horizontal counter 41. When the both count values are identical, the comparator 48 changes an output thereof from high to low, or low to high. The address counter 49 then counts up, and waveform information stored in the next address to the last address is read from the SRAM 45 to the comparator 48. When a count value included in the waveform information corresponds with a count value from the horizontal counter 41, the comparator 48 changes an output thereof from high to low, or low to high. In this way, waveform information is sequentially read from the SRAM 45. When a count value included in the read waveform information corresponds with a count value of the horizontal counter 41, the comparator 48 changes an output value thereof to thereby create charge read pulses and vertical transfer pulses including rectangular pulses.

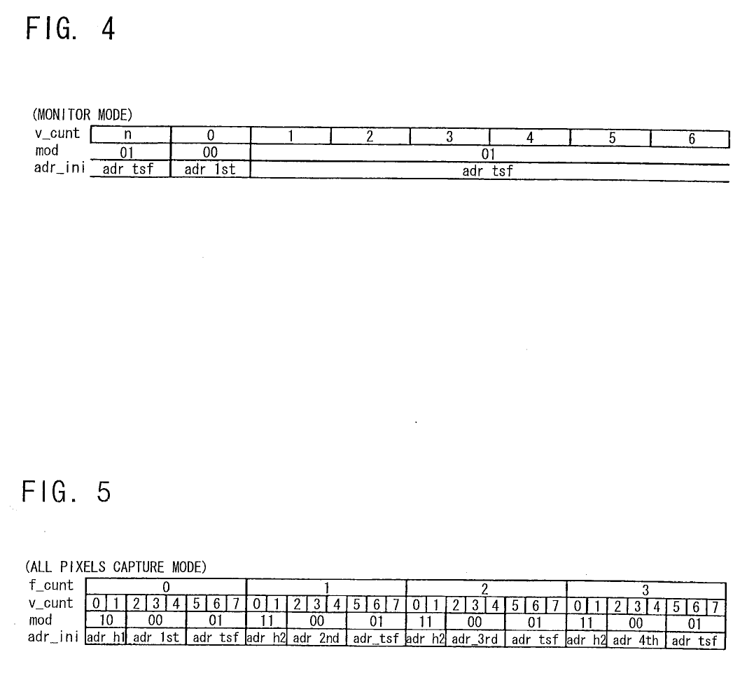

FIG. 4 and FIG. 5 show the operation information stored in the above operation information storing register device 47. The above solid-state image sensing device 1 can be set to four operation modes of a charge read mode for reading electric charges from pixels to the vertical registers, a transfer mode for transferring the read electric charges from the vertical registers to the horizontal register, and two high-speed discharge modes for discharging at a high speed electric charges that have leaked into the vertical registers from the pixels.

FIG. 4 shows operation information in a monitor mode set in displaying moving images (through images). As illustrated, there are stored a count value v_cunt of the vertical counter, operation mode information mod for the solid-state image sensing device, and a storage start address adr_ini for the waveform information stored in the SRAM.

An all pixels capture mode, which is set in recording static images, is a mode for reading electric charges of all pixels to constitute one screen in four divided fields. FIG. 5 shows operation information in the all pixels capture mode. As illustrated, there are stored a count value f_cunt of the field counter, a count value v_cunt of the vertical counter, operation mode information mod for the solid-state image sensing device, and a storage start address adr_ini for the waveform information stored in the SRAM.

In the operation mode information mod shown in FIG. 4 and FIG. 5, “00” represents the charge read mode, “01” the transfer mode, “10” a first high-speed discharge mode, and “11” a second high-speed discharge mode. In the storage start address adr_ini, “adr 1st”, “adr 2nd”, “adr 3rd” and “adr 4th” represent storage start addresses for waveform information on charge read pulses for reading electric charges of pixels in a first field, second field, third field and fourth field, respectively. In addition, “adr tsf” represents a storage start address for waveform information on a vertical timing pulse for transferring the electric charges read from the pixels to the horizontal register. Further, “adr h1” and “adr h2” represent storage start addresses for waveform information on vertical timing pulses for performing the first high-speed discharge operation and second high-speed discharge operation, respectively.

The monitor mode sets an initial address in the address counter 49 shown in FIG. 3 based on the operation information shown in FIG. 4. Specifically, the comparator 48 sets in the address counter 49 the storage start address “adr 1st” for waveform information on a charge read pulse for reading electric charges of pixels in the first field when the count value of the vertical counter 42 is “0”, and thereafter sets in the address counter 49 the storage start address “adr tsf” for waveform information on a vertical timing pulse for transferring the electric charges read from the pixels to the horizontal register when the count value of the vertical counter 42 turns “1”.

On the other hand, the all pixels capture mode sets an initial address in the address counter 49 based on the operation information shown in FIG. 5. Specifically, the comparator 48 sets in the address counter 49 the storage start address “adr h1” for waveform information on a vertical timing pulse for performing the first high-speed discharge operation when the count value of the field counter 43 is “0”, and the count value of the vertical counter 42 is “0”, and thereafter sets in the address counter 49 the storage start address “adr 1st” for waveform information on a charge read pulse for reading electric charges of pixels in the first field when the count value of the vertical counter 42 turns “2”. When the count value of the vertical counter 42 turns “5”, the address counter 49 is set to the storage start address “adr tsf” for waveform information on a vertical timing pulse for transferring the electric charges read from the pixels to the horizontal register.

Thereafter, when the count value of the field counter 43 turns “1”, and the count value of the vertical counter 42 is reset to turn “0”, the address counter 49 is set to the storage start address “adr h2” for waveform information on a vertical timing pulse for performing the second high-speed discharge operation. Similarly, the following storage start addresses for waveform information are set in the address counter 49 based on the count value of the field counter 43 and the count value of the vertical counter 42.

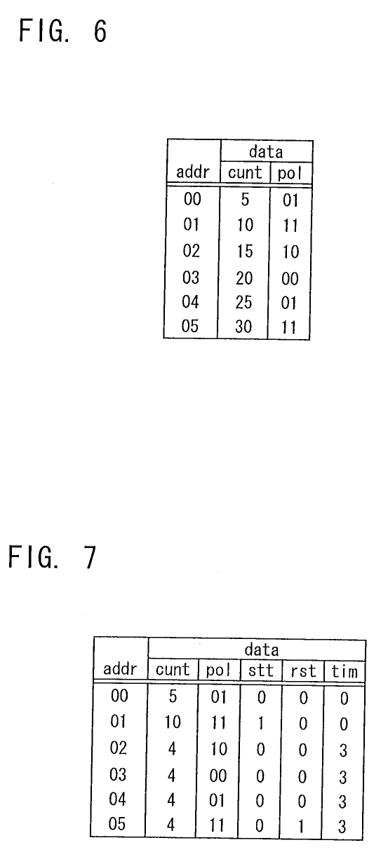

FIG. 6 and FIG. 7 show examples of waveform information stored in the above SRAM 45. FIG. 6 shows an example of waveform information on vertical timing pulses for transferring electric charges read from pixels to the horizontal register. Each address addr stores a count value cunt of the horizontal counter at a rise time point and fall time point where the polarity changes, and a polarity pol. The polarity pol has the same bit number as the number of vertical timing pulses to be created. Each bit data takes a value of “0” or “1”. FIG. 6 shows the polarity of only the first vertical timing pulse and second vertical timing pulse among the first to sixth vertical timing pulses.

On the other hand, FIG. 7 shows an example of waveform information on vertical timing pulses for performing a high-speed discharge operation. During the high-speed discharge operation, vertical timing pulses with the same waveform are repeatedly created. Each address addr in the SRAM stores a count value cunt of the horizontal counter, a polarity pol, start data stt showing whether or not it is a data start address for a pulse to be repeated, end data rst showing whether or not it is a data end address for the pulse to be repeated, and frequency data tim representing a frequency of repetition of the pulse. The count value cunt of the horizontal counter represents, for a pulse not to be repeated, a count value at a rise time point and fall time point when the polarity changes, and represents, for a pulse to be repeated, an increment from the last rise time point or fall time point. The polarity pol has the same bit number as the number of vertical timing pulses to be created. Each bit data takes a value of “0” or “1”. FIG. 7 shows the polarity of only the first vertical timing pulse and second vertical timing pulse among the first to sixth vertical timing pulses. Further, the start data stt takes a value of “1” for representing that it is a data start address, or a value of “0” for representing that it is not a data start address. The end data rst takes a value of “1” for representing that it is a data end address, or a value of “0” for representing that it is not a data end address.

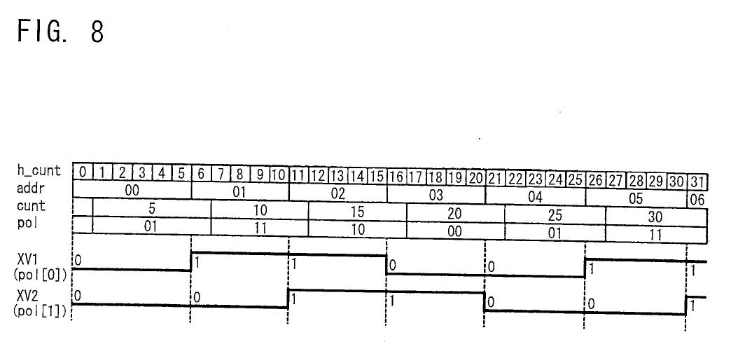

FIG. 8 shows how the first vertical timing pulse and second vertical timing pulse are created based on the waveform information shown in FIG. 6. The horizontal counter starts counting up after the count value thereof is initialized to “0”. A first output value XV1 and second output value XV2 of the comparator 48 have an initial value thereof set to “0”.

First, the address counter is set to an address addr “00” to cause a count value cunt “5” and polarity pol “01” stored in the address to be read from the SRAM. Thereafter, the first output value XV1 changes from “0” to “1” at a time point when the count value h_cunt of the horizontal counter turns “5”.

The address counter then counts up by one to cause a count value cunt “10” and polarity pol “11” to be read from an address addr “01” in the SRAM. Thereafter, the second output value XV2 changes from “0” to “1” at a time point when the count value h_cunt of the horizontal counter turns “10”. Similarly, the address counter counts up one by one to cause the following count values cunt and polarities pol stored in the SRAM to be sequentially read. The first output value XV1 or second output value XV2 changes at a time point when the count value h_cunt of the horizontal counter corresponds with the read count value cunt. In this way, the first output value XV1 of the comparator 48 changes to thereby create the first vertical timing pulse, while the second output value XV2 changes to thereby create the second vertical timing pulse. The third to sixth vertical timing pulses are also created similarly.

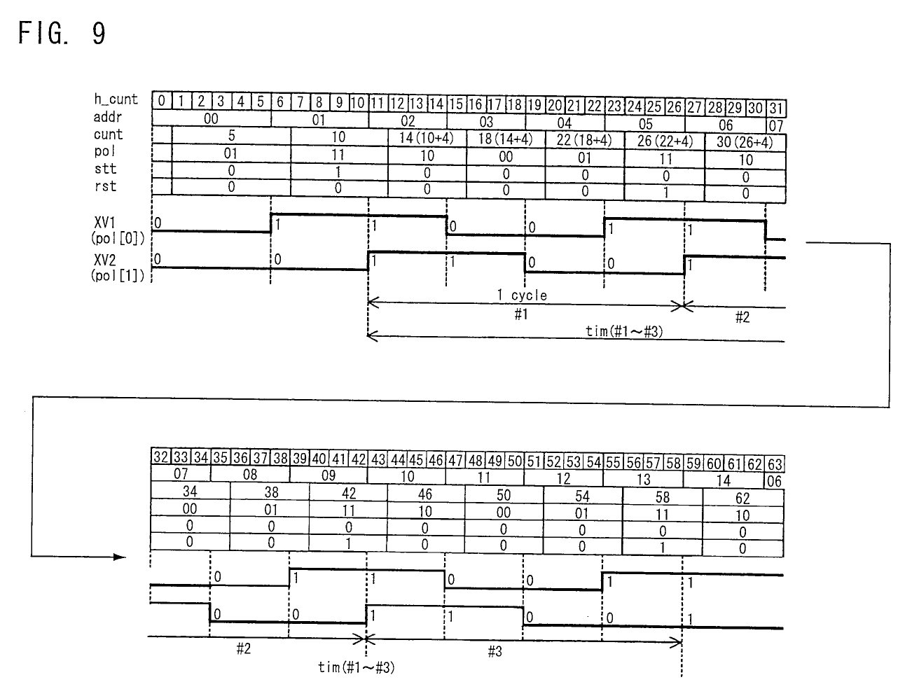

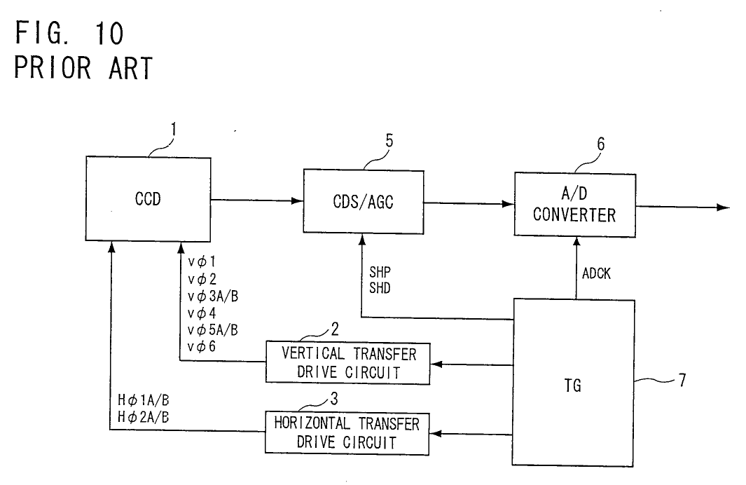

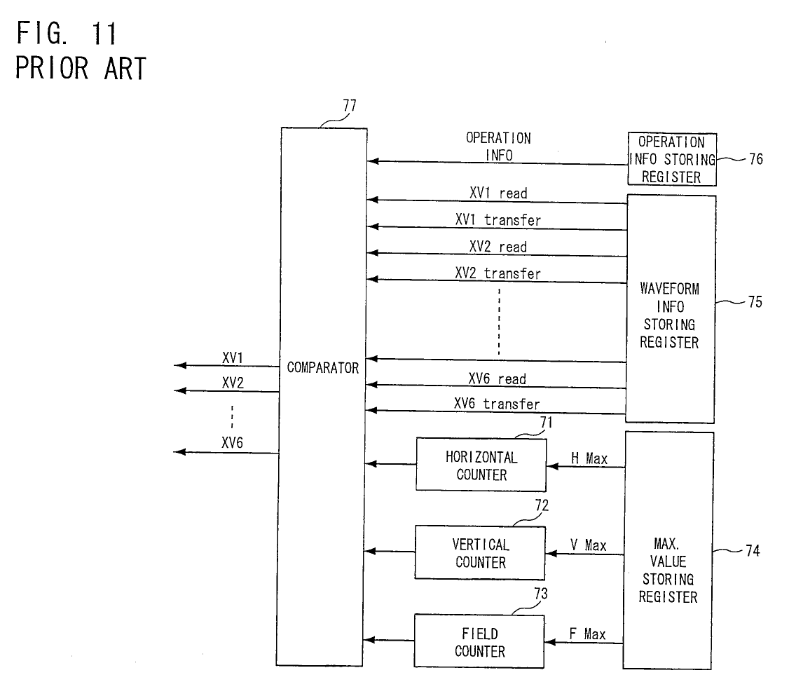

FIG. 9 shows how the first vertical timing pulse XV1 and second vertical timing pulse XV2 are created based on the waveform information shown in FIG. 7. The horizontal counter starts counting up after the count value thereof is initialized to “0”. A first output value XV1 and second output value XV2 of the comparator 48 have an initial value thereof set to “0”.

First, the address counter is set to an address addr “00” to cause a count value cunt “5”, polarity pol “01”, start data stt “0”, end data rst “0” and frequency data tim “0” stored in the address in the SRAM to be read. Thereafter, the first output value XV1 changes from “0” to “1” at a time point when the count value h_cunt of the horizontal counter turns “5”.

The address counter then counts up by one to cause a count value cunt “10”, polarity pol “11”, start data stt “1”, end data rst “0” and frequency data tim Coon to be read from an address addr “01” in the SRAM. Thereafter, the second output value XV2 changes from “0” to “1” at a time point when the count value h_cunt of the horizontal counter turns “10”.

The address counter further counts up by one to cause a count value cunt “4”, polarity pol “10”, start data stt “0”, end data rst “0” and frequency data tim “3” to be read from an address addr “02” in the SRAM. Thereafter, the first output value XV1 changes from “1” to “0” at a time point when the count value h_cunt of the horizontal counter turns “14”, which is the sum of the count value “10” read last time and the count value “4” read this time. Similarly, the address counter counts up one by one to cause the following count values cunt, polarities pol, start data stt, end data rst and frequency data tim to be sequentially read from addresses addr “03”, “04” and “05” in the SRAM. The first output value XV1 or second output value XV2 changes each time the count value h_cunt of the horizontal counter increases by the read count value cunt.

Thereafter, the count values cunt of the horizontal counter and polarities pol stored in the addresses addr “02” to “05” in the SRAM are read twice. The first output value XV1 or second output value XV2 changes each time the count value h_cunt of the horizontal counter increases by the read count value cunt. In this way, the first output value XV1 and second output value XV2 of the comparator 48 change using the count values cunt of the horizontal counter and polarities pol stored in the addresses addr “02” to “05” in the SRAM three times to thereby create the first vertical timing pulse repeatedly three times with the same waveform, and create the second vertical timing pulse repeatedly three times with the same waveform.

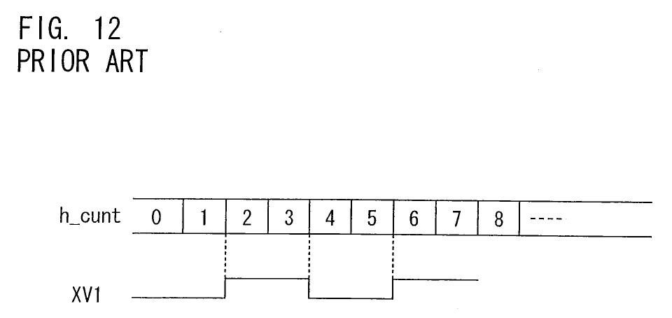

In the above solid-state image sensing device drive unit of the present invention, the SRAM 45 shown in FIG. 3 stores the waveform information on the charge read pulses and vertical timing pulses. The SRAM 45 needs to have only a single output terminal thereof connected to the comparator 48 because the SRAM 45 is a random access memory that allows one memory cell to be selectively accessed depending on the address. Although a plurality of registers constituting the address storing register device 46 must have output terminals thereof connected to the comparator 48, the address storing register device 46 stores a much smaller amount of information than the amount of information stored in the conventional waveform information storing register device 75 shown in FIG. 11. Therefore, the number of interconnect lines for connecting the address storing register device 46 and comparator 48 to each other is much smaller than that of interconnect lines for connecting the conventional waveform information storing register device 75 and comparator 77 to each other. Thus, the number of the interconnect lines between the comparator 48 and the SRAM 45 and address storing register device 46 is smaller than the number of the interconnect lines between the conventional comparator 77 and waveform information storing register device 75. This provides a simpler circuit configuration than a conventional one.

In addition, the above solid-state image sensing device drive unit of the present invention needs the comparator 48 to have only a single gate (not shown) for inputting thereto the waveform information from the SRAM 45. Although the comparator 48 must have gates for inputting thereto the addresses from the address storing register device 46, the number of gates for address input provided in the comparator 48 is much smaller than the number of gates for waveform information input provided in the conventional comparator 77. Therefore, a smaller number of gates than a conventional one are provided in the comparator 48 to make the comparator 48 smaller. This provides a smaller circuit scale.

The present invention is not limited to the foregoing embodiment in construction but can be modified variously by one skilled in the art without departing from the spirit of the invention as set forth in the appended claims. The waveform information on the charge read pulses and vertical timing pulses may be stored not only in the SRAM 45 as in the above embodiment, but also in another known random access memory, for example.

What is claimed is:

1. A drive unit for a solid-state image sensing device, comprising:
a randomly accessible memory for storing waveform information on a drive signal for the solid-state image sensing device; and
a signal creation circuit for reading the waveform information from the memory and creating the drive signal based on the read waveform information.

2. The drive unit for a solid-state image sensing device according to claim 1, further comprising a counter that counts up with a constant period, wherein the waveform information includes a count value of the counter at a time point when the drive signal changes in value, and the signal creation circuit compares a count value of the counter with the count value stored in the memory, and changes an output value at a time point when the both count values are identical.

3. The drive unit for a solid-state image sensing device according to claim 2, capable of creating a drive signal including a plurality of pulses having the same waveform, wherein the waveform information includes an increment of a count value of the counter between time points when the drive signal changes in value, and the signal creation circuit repeats an operation of changing an output value at a time point when the count value of the counter increases by the increment.

4. The drive unit for a solid-state image sensing device according to claim 1, further comprising an information store for storing creation start information representing a time point to start creating a drive signal, and address information representing a storage start address for waveform information on the drive signal, wherein the signal creation circuit starts reading the waveform information from the storage start address represented by the address information stored in the information store at the time point represented by the creation start information stored in the information store.
